(19) United States
(12) Patent Application Publication
(10) Pub. No.: US 2009/0068508 A1
(43) Pub. Date: Mar. 12, 2009

(54) APPARATUS AND METHOD OF PRODUCING ELECTRICAL CURRENT IN A FUEL CELL SYSTEM

(76) Inventor: James Bernard Martin, JR., Lake Elmo, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/876,486

(22) Filed: Oct. 22, 2007

Related U.S. Application Data
(60) Provisional application No. 60/853,246, filed on Oct. 20, 2006.

(51) Int. Cl. H01M 8/04; H01M 8/18

(52) U.S. Cl. 429/17; 429/19

(57) ABSTRACT

A method and closed system for producing electricity at more than one location. A reservoir containing an aqueous electrolytic solution produces hydrogen and oxygen gasses in separate chambers in an electrochemical reaction utilizing electrodes submerged in the chambers. The gasses are then introduced into a fuel cell, wherein the hydrogen is further split into protons and electrons, and the electrical current produced by the movement of the electrons is harnessed by a first generator. The hydrogen and oxygen are recombined in a second electrochemical reaction to produce water. The water then falls through a water column past a paddlewheel. The paddlewheel in turn rotates and the energy from the rotation is also harnessed. The water is then reintroduced into the reservoir.

### RELATED APPLICATION

This application claims the benefit of U.S. Provisional Application No. 60/853,246, filed Oct. 20, 2006, which is incorporated herein by reference in its entirety.

### FIELD OF THE INVENTION

The invention relates generally to electrochemical reactions. More specifically, the invention relates to an apparatus and method of producing electrical current in a fuel cell system.

### BACKGROUND OF THE INVENTION

The technology exists to create pure water from hydrogen gas and oxygen gas. A fuel cell can be used to put these gasses together, as well as other gasses. Fuel cells are well known in commerce and it is practicable to purchase such technology. The theory and technology of fuel cells, electrolysis of water, electromagnetic induction is discussed further in Appendix A, which is incorporated herein by reference.

In current fuel cell systems, gasses, such as, for example, hydrogen and oxygen gasses, are introduced into a fuel cell. Hydrogen fuel is fed into an anode and oxygen enters through a cathode. The hydrogen atom splits into a proton and an electron in the presence of a catalyst, which take different paths to the cathode. The proton passes through an electrolyte, such as a polymer membrane. The electrons create a separate current that can be utilized and harnessed before they return to the cathode. The hydrogen and oxygen then recombine to form water. The water byproduct can be collected, for example, in a bladder.

Current fuel cells can be run at high efficiencies, such as upwards of 90%. However, the components of the system need to be continually replaced, such as the electrolyte for the electolysis, and the electrolyte of the fuel cell. Energy must be continually introduced into the system to operate electrodes submerged in the electrolyte.

Additionally, unused products escape through exhaust, which contributes to the inefficiencies of fuel cells. One reason for an exhaust in a fuel cell is that impurities from an air inlet, which is the source of oxygen gas, for example, need to be removed. In doing so, some of the product is lost as well.

There remains a need for an electrochemical system and method, such as a fuel cell, that uses the byproducts of electrochemical reactions to produce energy to fuel the system.

### SUMMARY OF THE INVENTION

The present invention is directed to a unique system and method of producing electrical current in a system via harnessing the energy mutually produced by the rising gases through solution, releasing of said gases under pressure, a reaction (electrochemical or otherwise) involving said gases to produce liquids, the descent of said liquids, and the separation of said solution into said gasses.

Inventor has found a process and method that includes a new and useful integration of known processes that produces unexpected results such as the production of electrical current in a closed system to at least partly sustain the system. A substance, such as water, is split into byproducts, such as hydrogen and oxygen gasses, via an electrochemical reaction. These byproducts are then merged together in a second electrochemical reaction to create the original substance. In splitting the substance and merging its byproducts, a primary electrical current will be created. In the transference of the byproducts and the substance, generators, particularly a paddlewheel in a water column, are driven which produce a secondary electrical current. Such a system can produce enough electrical current to sustain the system, and additional current to be converted and/or transformed for consumption by an outside source.

The above summary of the invention is not intended to describe each illustrated embodiment or every implementation of the present invention. The figures and the detailed description that follow more particularly exemplify these embodiments.

### BRIEF DESCRIPTION OF THE DRAWINGS

FIG. 1 is a block diagram according to an embodiment of the present invention.

FIG. 2 is a block diagram of a mechanization of the process according to an embodiment of the present invention.

FIG. 3 is a rotor with magnetic bearings according to an embodiment of the present invention.

FIG. 4 is a diagram of brush circuitry for brushes on the rotor of FIG. 3.

FIG. 5 is a graph of magnetic flux density.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION OF THE INVENTION

Because the gaseous byproducts of electrolysis will rise, and water is created from fuel cells, that water may be collected in a reservoir. The reservoir of the present invention may then be used to split the water into hydrogen and oxygen to be re-circulated in the system of the present invention. As the water falls from the top to the bottom, it may be used to turn turbines to produce electricity (as discussed below).

The method and system of the present invention can also be used with other components, such as electrolysis of oxygen rich methane to produce carbonic acid, or on liquids to form other liquids. Although the examples specifically described the electrolysis of water and its subsequent recombination, it is understood that one of ordinary skill in the art would recognize that the method and system are not limited to electrolysis of water to create hydrogen and oxygen byproduct, but rather encompasses other suitable components.

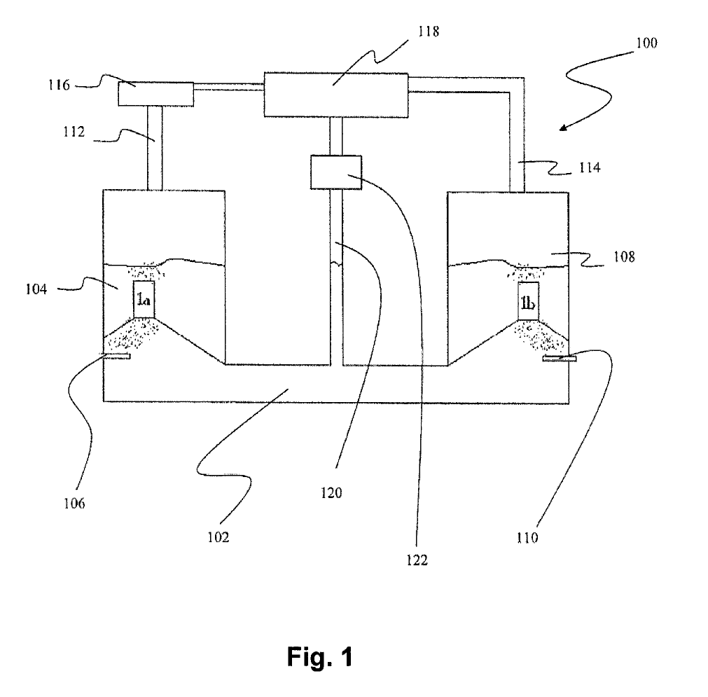

According to one aspect of the present invention and referring to FIG. 1, a system 100 includes an electrolysis reservoir 102 comprising at least a first chamber 104 having a first electrode 106, and a second chamber 108 having a second electrode 110. Direct current (DC) may be run through an aqueous sulfuric acid solution via electrodes 106 and 110 submerged in the electrolyte in an electrolysis reservoir 102. As the water in the sulfuric acid solution splits into hydrogen and oxygen gas, bubbles rise through the solution, for they are less dense. For example, hydrogen gas is produced at first electrode 106, and rises into a first exit pathway 112. Oxygen is produced at second electrode 110, and rises into a second exit pathway 114.

Referring to FIG. 1, a turbine may be spun in the solution by such rising bubbles at each electrode, marked as “1a” and “1b” respectively. When the gasses are contained, they are under pressure. The hydrogen gas may then be released to spin a hydrogen pressure turbine 116. The oxygen and hydrogen gasses then react with each other in an electrochemical reaction via a reaction vessel 118, such as a fuel cell.

Reaction vessel 118 can comprise a fuel cell, as described here, in which a generator (not shown) positioned in reaction vessel 118 can capture the current produced by the further splitting of the hydrogen gas into protons and electrons in the presence of an anode and a catalyst. The protons and electrons take separate paths to the oxygen at a cathode. The electrons produce a current that is captured by the generator. At the cathode, the hydrogen recombines with oxygen. The byproduct, pure water, is then dropped down in a water column 120 to mix back into solution. Upon dropping said byproduct, its potential energy is captured by a generator 122, such as a water turbine or paddlewheel.

In an alternative embodiment, in the fuel cell according to the present invention, the exhaust for the pure water and entrance for the oxygen may be the same chamber. In that case, the pressurized oxygen gas cannot be used to turn a turbine to produce electricity.

Other reaction vessel designs can also be incorporated, and as described above, the gasses are not limited to hydrogen and oxygen. Any number of suitable reaction vessels and their associated electrochemical reactions can be incorporated into system 100.

The Law of Conservation of Energy states that no system can produce more energy than it consumes, and is illustrated as follows. By way of example, assume that one hundred amperes at one volt are put into the electrolysis of water, the merging of the oxygen and hydrogen gasses produced by a fuel cell 118 could produce no more than one hundred watts. If the fuel cell produced only ninety-seven amperes at one volt, three watts would be lost in the process. If the water byproduct and the current produced were reintroduced into solution and the electrolysis of the water, the system would soon fail, as implied by the Law of Conservation of Energy. This directly implies that other electrical energy sources are needed to sustain the system.

As described above, other energy sources are needed to sustain the system. According to an embodiment of the present invention, by harnessing energy from rising gasses, falling liquids, and pressurized gasses, mechanisms like DC generators may be used to produce the three watts needed in total to sustain the above mentioned system. Pursuant to one aspect of the invention, there may be four turbines harnessing energy: hydrogen gas turbine 1a, oxygen gas turbine 1b, hydrogen pressure turbine 116, and water turbine 122 and as such there may be four separate DC generators creating current for electrolysis. If each generator produced one amp at one volt, the system of the present invention could sustain itself and produce an extra watt that could be used externally.

The generation of electricity should be regulated, because introducing the extra current into the system may increase the pressure of the gasses, in this case hydrogen and oxygen and such gasses under extreme pressure may explode. Therefore, a regulating device may be connected to pressure sensors to monitor the pressure of the gasses. Pressure sensors may also be placed at the fuel cell to prevent tearing of the membrane and at the electrolysis cell to prevent breaking of its container. The regulating device may also be responsible for exporting any extra current created.

The invention is described further in the detailed analysis and example of the method and system:

Supposing that X-Watts are introduced into an electrolysis chamber of an aqueous sulfuric acid solution to split into its principal parts, a fuel cell consuming said gasses produced could generate no more than X-Watts. The electrolysis chamber can then consume the X-Watts produced by the fuel cell. Furthermore, the hydrogen and oxygen gas consumed will produce the exact amount of water split in the electrolysis chamber and can be reintroduced into the chamber. Theoretically, this exchange of current and matter between electrolysis and fuel cell is perpetual. As is common knowledge, this system alone will fail in practice, as described below.

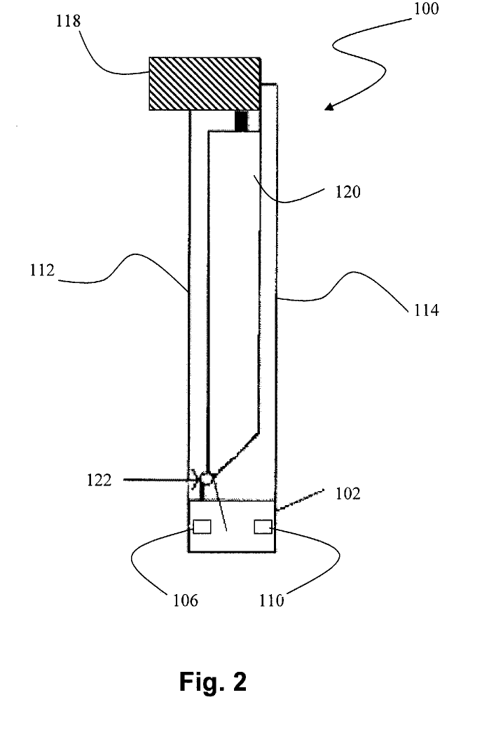

To sustain such a system described above, electrical current must be introduced into the electrolysis chamber. The natural separation of water produced by a fuel cell and the gasses produced in the electrolysis chamber can be harnessed for just that purpose. In collecting the water produced by the fuel cell in a column, gravitational pull against a paddlewheel could create circular motion to spin an induction dynamo producing the necessary amount of electricity to sustain the system. Excess electrical current produced by the system could be exported. For an illustration of the apparatus in its entirety, see FIGS. 1 and 2. The water produced by a fuel cell is in the form of vapor and would need to be condensed. Such condensation could be accomplished via manipulating naturally occurring temperatures and pressures, for example, or by a compressor. The machine described may have to be altered slightly to accomplish such an act.

As described, this machine is a stand-alone power plant. Required foreseen maintenance includes the replacement of worn seals from heat, worn bearings from stress, and the corrosion of electrodes from electrolysis impurities. The induction dynamo would also show wear on their plating and brushes from friction, and the magnets' strength would deteriorate simply by existing. The system and method is described in terms of physics and thermodynamics below.

### Summary of Physics

Energy is simply the amount of force applied over a certain distance. In short, the unit of measuring energy, the Joule, has the units Newton-meter. As an example, if a man pushes a 15 kilogram box 7-meters (given the acceleration of gravity is 9.8 m/s², and assuming the highest coefficient of friction possible, or 1.0), he would perform 1029 Joules of work because there is 1029 J of energy holding the box down due to gravitational friction. Thus, energy-in equals energy-out and the system is sustained.

It would be much easier to calculate individual force equilibriums found in the system. In the example above, box has a frictional force of 147 Newtons. Therefore, the man needs to apply 147 N of force to move the box; no more and no less. This calculation of equilibrium is much easier to find and no different from the work-energy equivalence, as both are divisible by the 7-meter distance in which the force is applied. Therefore, the work-energy equivalence is congruent to the abovementioned force equilibrium when implemented correctly.

Next, pressure is defined as the amount of force applied over a given area. If the box in the above example made contact with the ground over an area of 3 m², the pressure al the point of contact would be 49.0 N/m² or 49.1.1 Pascal. The amount of force can then be found by noting a given area (assuming the pressure is evenly distributed), such as a 0.500 m² section, which would have a force of 24.5 N. Considering that there are six half square meter sections making contact between the ground and the box, a total force or 147 N (=6*24.5) is being applied over the entire area.

Third, torque is the way in which force is applied. Considering a simple lever, such as a seesaw, the torques must be equal on either side of the fulcrum in order to balance. If a 300-pound man sat five feet from a seesaw's, center, his seat is said to have 1500 foot-pounds of torque. In order to balance, the opposite seat must have 1500 foot-pounds of torque. If a 100-pound man sat fifteen feet from the seesaw's center, his seat would have 1500 foot-pounds of torque. As the torque of each side is equal, the lever is in balance.

### Water Column

Upon exhausting the pure water byproduct from the fuel cell 118, it is captured in a water column 120 before being reintroduced into the aqueous sulfuric acid solution in the electrolysis chamber. Such a water column will provide pressure to turn a paddlewheel. Considering that the column is capturing the water byproduct of the fuel cell, the water column maintains pure water that has a density of 1000 kg/m³). As an example, assume that the water column is 1 m in height. If the column were 1 m² in width and depth, the force applied by gravity would be 980 N, and pressure applied the cubic meter of water at the bottom of the column would be 980 Pa. If the column were 100 m2, the force applied by gravity would be 98,000 N, and pressure at the bottom would be 980 Pa. As implied, the water pressure is dependant only upon height, not the width depth of the column. Pressure in Pascal, p, at a given height in meters, h, is formulated by P=980 h.

Gravity's pull on the water will provide enough force to spin a paddlewheel to convert the linear motion of the falling water into circular motion to spin an induction dynamo. After the water's release, it can either be captured by another water column, or reintroduced into the aqueous sulfuric acid solution. To find the force applied to a paddlewheel, the area of the paddle in square meters, A, must be known. The force applied in Newtons, f, is then formulated by F=P*A.

Now, the necessary height of the water column can be formulated given the force required and the area of the paddle by F=980 h*A, or h=F/(980 A). This formula will be used to determine the height of the water consumed after the induction dynamo is designed and the dimensions of the paddlewheel are known.

Lastly, the amount of water consumed by the paddlewheel must be replaced in order to sustain the required depth of the water column. If too much water enters the water column, the paddle wheel will have more force placed upon its paddles and will spin up to accommodate this change. Consequently, if not enough water is replenished, the paddlewheel will slow. These changes will continue until equilibrium is reached.

Therefore, the speed of the puddle wheel can be controlled by the amount of water introduced into the water column. On a side note, the amount of water exhausted from the water column must be replaced by the fuel cell to maintain equilibrium.

### Paddlewheel

As an example, a paddlewheel 122 has a radius measured in meters, r, and a width measured in meters, w, and mass measured in kilograms, m. Each paddle has the same width equal to that of the width of the wheel, and are of a length measured in meters, l, with thickness measured in meters, c. The thicknesses of the paddles are equivalent and measured as chords of the paddlewheel. The paddlewheel is sealed with a distinct entry and exit so only a certain volume is expelled per rotation. Given the simple geometric formulas:

θ=s/r,

θ=2arcsin(c/2r), and

A=rs/2,

the volume of each paddle is found to be: w 1(2r−1) arcsin(c/2r). Thus, the volume of water expelled is equivalent to

wπr²−wπ(r−1)²−wln(2r−1)arcsin(c/2r)=wl(2r−1)(π−n*arcsin(c/2r)),

where n is the number of paddles on the paddlewheel.

To determine how much force is required at the paddle, torque must be calculated. The average radius at which the force is applied is simply rₐ=r−1/2. Therefore, the torque of the paddlewheel as a function of the required force applied, F, is τ_{w}=F rₐ=F (r−1/2). Given the amount of torque required by the paddlewheel, the amount of force required to be placed upon the paddle is found by F=τ_{w}/(r−1/2).

Gravitational force pulling down on the paddlewheel output shaft against a seal will create a frictional drag. Therefore, force is required to he placed on the paddle to sustain its motion. The frictional force is found by F_{g}=μ_{K-B} 9.8 m, where μ_{K-B} is the kinetic coefficient of friction between the output shaft and the bearings. Such force is applied at the radius of the output shaft in meters rₛ, so a gravitational back-torque of: τ_{g}=μ_{K-B} 9.8 m rₛ is put on the paddlewheel.

The pressure from the seal against the output shaft is nominal, but worth discussing. Frictional force is equivalent to pressure of the seal in Pascal, pₛ, times the area in which the pressure is distributed in square meters, A, times the coefficient of kinetic friction between the shaft and the seal, μ_{K-S}, or F_{F}=μ_{K-S} A. The area is equivalent to the circumference of the output shaft times the thickness of the seal in meters, tₛ. so F_{F}=p_{S} μ_{K-S} t_{S} r_{S}. Such force is applied at the radius of the output shaft, so a frictional back-torque of τ_{F}=p_{S} μ_{K-S} t_{S} r_{S}², is put on the paddlewheel.

The net torque required insofar to sustain the paddlewheels motion can now be found as the sum of the aforementioned torques, or τ=τ_{g}+τ_{F}=μ_{K-B} 9.8 m rₛ+p_{S} μ_{K-S} t_{S} r_{S}².

### Induction Dynamo—Induction

Being ultimately turned by a paddlewheel, the induction dynamo creates the supplemental current for the system. Considering that two discussions of the dynamo must exist, this part shall refer to the electrical generation versus the physical characteristics. Michael Faraday's Law of Induction states that an electromotive force (EMF) will be induced ill any conductor moving across magnetic flux lines, and is proportional to the rate at which the flux lines are being cut. EMF is measured in Joules per Coulomb (Volts). By controlling flux density, the length of the conductor immersed in the field, and the velocity at which the conductor moves, the voltage and can be regulated.

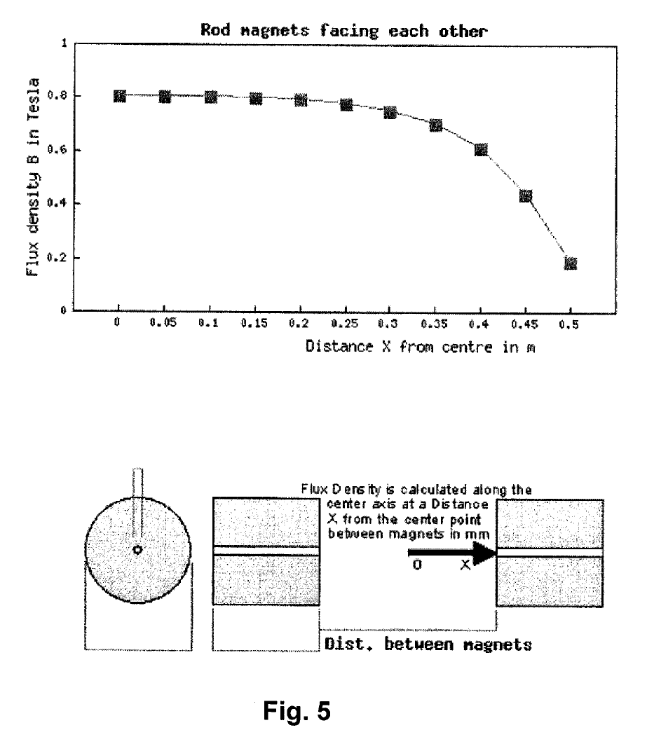

When Michael Faraday discovered electromagnetic induction, he moved a conductor through lines of magnetism. His rule of induction states that E=B 1 v, where E is measured in m² kg/s³ A (Volts), B is the flux density of the magnetic field in kg/s² A (Tesla), 1 is length of the conductor's protrusion into the field in meters (working area), and v is the velocity or the conductor in m/s. An example of flux density data is shown in FIG. 5.

Assume that a sheet having a width of 2πr and length of r passed its entire length through the field in s seconds. An EMF will be induced by the sheet equivalent to (B)(r)(r/s). Now assume a disc with radius r passed through the same field for an entire rotation. Take notice that the circumference of the disc is the same as the width of the sheet, and the radius of the disc is the same as the length of the sheet. The area of the sheet that passed through the field is 2πr². Being twice that of the sheet, the area of the disc that passed through the field is πr². Thus, the disc would induce only half of the EMF induced by the sheet. Furthermore, velocity would be measured in rotations, as one rotation of the disc is equivalent to one passing of the sheet. An EMF would be induced by the disc equivalent to (1/2)(B)(r)(r*f), where f is the number of revolutions of the disc per second. Given that the plane of a disc is perpendicular to the direction of the magnetic field, the induced EMF generated in volts, E, between the center and the edge of the disc is E=1/2 B r²f, given the magnetic flux density in Teslas, B, the working radius of the disc in meters, r, and the angular frequency of the disk in revolutions per second, f.

In virtually all cases, the resistance of the rotor disk itself is and should be entirely negligible. The only foreseen and primary electrical resistance in a disc dynamo is that of the brushes. Between the brush and the rotor, there is a discharge contact zone that is mostly responsible for brush heating. Therefore, it is essential to use the highest quality brushes that have very high conductivity and a very low coefficient of friction as the heating can be as much as three times that of the brush resistance itself.

The total resistance, R, is dependant on a few things: first, the number of poles drawing amperage from the induction dynamo, Nₚ; second the number of brushes per pole; and third the resistance of the electrical device usually defined by the manufacture, R_{D}. he number of brushes per pole is split between those on the edge of the rotor, B_{D}, and those on the shaft, Bₛ. Then, total resistance can be formulated as R=(R_{D}/B_{D}+R_{D}/B_{S})/Nₚ.

Current is described with two variables: voltage and amperage. So, the question naturally materializes regarding the amount of amperage produced. Given a certain resistance of the brushes measured in Ohms, R, and the EMF induced, the induced current in Amperes, A, is formulated by A=E/R. It is by these formulas that a current is described in amperes and voltage.

### Induction Dynamo—Rotor

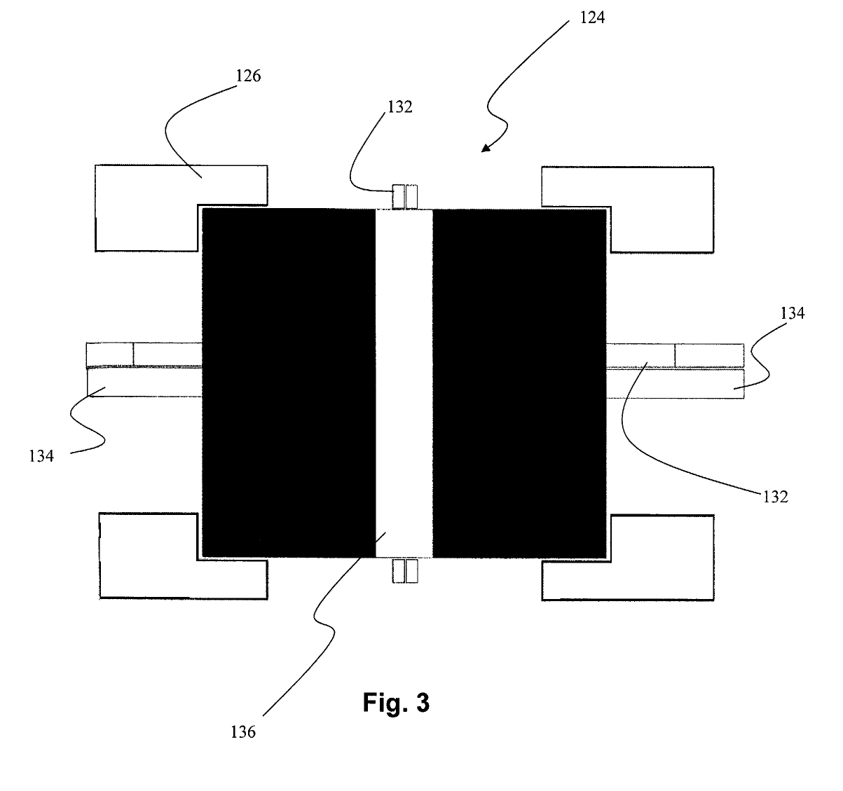

The following is a discussion of a rotor 124 of the induction dynamo (see FIG. 3). Back torque proportional to the load current is produced when the induction dynamo has a stator. Therefore, a statorless unipolar generator is described to eliminate said back torque. The rotating inertia is very high due to the increase in mass from the attached magnets, but the input power required is much lower than that of a generator with a stator. The attached magnets must be non-conductive (with lower residual induction).

Back-torque, τ, is put on the rotor 124 formulated by τ=p μ_{K} A r, given the pressure of the brushes in Pascal, p, the kinetic coefficient of friction, μ_{K}, the contact area of the brush in square meters, A, and the radius at which the brushes make contact, r. This is the only back-torque observed which is required to sustain the motion of the induction dynamo. Considering that high power magnets 126 are attached to the dynamo and in motion with the rotor, stationary magnets with opposite poles can be used to push the rotor 124 away from the ground. Such stationary magnets can also be used to control the horizontal positioning of the rotor, thereby controlling its locality, and ultimately the locality of the dynamo. (The brushes also control the positioning of the dynamo as they have contact with its edges). Shielding should be put into place to screen any unwanted magnetic interference. Having in mind the lack of contact between a support and the dynamo due to magnetic suspension, no back-torque from gravitational friction is observed.

The contact area along the edge of the disc, and the contact area along the edge of the shaft must be equal. To better estimate the dimensions of the rotor, a few things must be known. First, a technical description of the brushes is given. As found on advancecarbon.com, the S-93 brush has an apparent density of 6.40 Gm/cc, Shore hardness of 10, a flexural strength of 6,000 Lbs/in², a very low voltage contact drop, a low coefficient of friction, a permissible current density of 300 Amps/in², contains 93% silver, has a maximum contact rate of 6,500 feet per minute (33 m/s), resists 2 micro-ohms, and suggests a minimum brush pressure of 4 psi (27.586 kPa). Also, it is known that the kinetic coefficient of friction between silver and itself is 0.2.

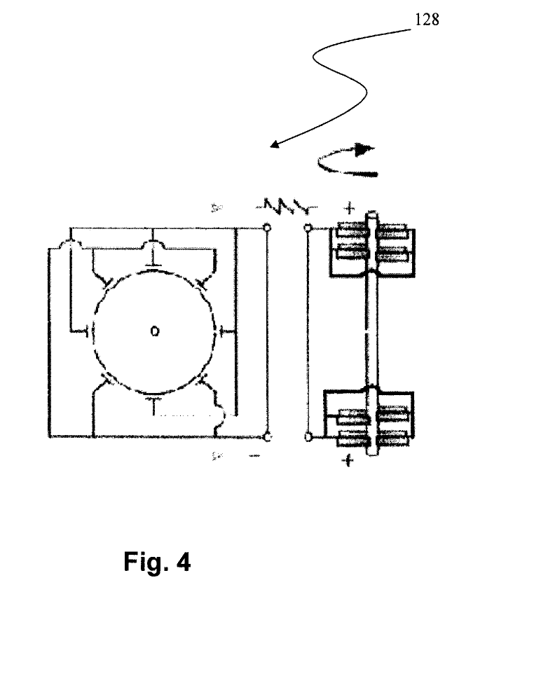

Second, a description of the brush system 128 is needed. The brush system 128 will have four poles, each pole having four brushes 132 on the disc 134, and four on the shaft 136 (see FIG. 4). A quick calculation yields a total resistance of R=(0.000002/4+0.000002/4)/4=(0.0000005+0.0000005)/2=0.00000025 Ohms. Knowing that approximately 3.5 Volts will be required, the total potential maximum amperage is calculated as A=E/R=3.5/0.00000025=14,000,000 Amperes at 3.5 Volts. A calculation knowing that the permissible density of the brush is 465,000 Amps/m². The maximum contact area required is about 30.1 m² for each the disc and the shaft.

Third, technical descriptions of the magnets are needed. The Magnetic Flux Density changes proportionately to the distance from the magnet. Most magnets are measured in Gauss, and is equivalent to 10,000*Tesla. According to magneticsolutions.com.au, the grade-N48 NdFeB magnets have a residual induction of 13800-14200 gauss, or an average of 1.4 T. The magnets also have an average density of 7.5 g/cm³.

### EXAMPLE CALCULATIONS

Assume that the induction dynamo will produce 3.50 V. Secondly, the outer radius of the magnets and rotor disc will be 3.00 m, and the inner radius of the magnets and rotor shaft will be 0.25 m. The thickness of the magnets will be 3.00 m, and the thickness of the rotor disc will be 1.00 m.

The magnetic flux density varies regarding the distance from the magnet, so the average flux density is found. By keeping the brushes at the disc's center, the average flux density is found as B=0.80 T (See FIG. 5). It can be derived that 3.5=(1/2)(0.80)(3.00)²(f), or the frequency required would be f=0.97 rps.

The circumference of the disc is 6.00 μm. As such, the brushes are running 18.28 m/s. which is well under their limit of 33 m/s. As a matter of fact, the rotor 124 could potentially rotate up to 1.75 rps, and stay under the 33 m/s manufacture limit. At such an angular velocity, an EMF of 6.30 V would be generated.

It is derived that the disc brushes will be 0.20 m in width. If four brushes were run on two poles in the given width on both sides (bipolar parallel circuitry, FIG. 4), a total of sixteen brushes would be run on the disc. Assuming that the brushes ran the circumference of the disc, the total required surface area would be 2.40 πm². Now assuming that the brushes also ran the circumference of the shaft, the exposed shaft would have to be 4.80 m in length. Splitting the difference, a minimum of 2.40 m would protrude from either side of the magnets. The maximum amperage that can be run through the brushes is 465,000 Amps/m². Considering the contact area, 3,510,000 Amp would be produced if the induction dynamo were operating in the parameters defined.

The brushes themselves would need to be spaced apart from each other. Considering the rotor 124 is plated in sliver, the circumference will be larger than previously mentioned. This increase in circumference will supply some of the needed space. Now, assume the brushes made contact slightly above the recommended pressure at 28 kPa. The amount of torque required to keep the disc dynamo turning would be

τ=(28000)(0.2)(2.40)(3.00+0.25)=43,700πNm.

Further, assume, for example, that the radius of the paddle wheel is to be 2.00 m, its width is to be 5.00 m, the length of its paddles it to be 0.100 m, their thickness are to be 0.050 m, and there are to be 250 paddles. The output shaft is to have a radius of 0.75 m, the seal is to be 0.025 m thick with a pressure of 25 kPa. The mass of the paddle wheel in general is to be 500 kg. (Strong and light plastics machined with certain building techniques exist that will meet or exceed said mass). Assume the paddle wheel spins the same number of revolutions as the induction dynamo: a 1:1 rotation ratio. No gearing ratio is necessary.

As derived earlier and assuming each applicable kinetic coefficient of friction is 0.2, the torque required to sustain the motion of the paddlewheel is:

μ_{K-B}9.8mrs+p_{S}μ_{K-S}t_{S}r_{S}²=(0.2)(9.8)(500)(0.75)+(25000)(0.2)(0.025)(0.75)²=740+70=810 Nm.

Summing this with the torque required to keep the induction dynamo in rotation yields the total torque required to be produced by the paddlewheel of 43,7007π+810, or almost 140,000 Nm.

The torque is to be exerted 1.95 m from the paddlewheel's center. As such, slightly less than 71,800 N of force is to he exerted on each paddle whose area is 0.500 m². Given this information, the pressure required to be placed upon each paddle is nearly 144,000 Pa. This allows the calculation of the water column's height: 144,000=980 h, or nearly 147 m. The final question is in regards to how much water is exhausted by the paddlewheel per unit of time. As derived earlier, every rotation of the paddlewheel will expel w 1 (2r−1)(π−n*arcsin(c/2r)) m³ of water. Given the assumptions above, every rotation will expel

(5.00*0.100)(2*2.00-0.100)(π−250*arcsin(0.0125))=(0.500)(3.90)(π−250*0.0125)=(1.95)(3.14-3.13)=1.95*0.010=0.0195 m³/rev.

Given the speed of 0.97 rev/s, slightly less than 0.0201 m³ of water will be expelled per second.

### Electrolysis Chamber and Fuel Cell Stack

Direct Current (“current”) is run through an aqueous sulfuric acid solution via electrodes submerged in the solution. As the water splits into hydrogen and oxygen gas via electrolysis, bubbles rise through solution off each electrode and collect in separate chambers. Noting that water has a density or 1000 kg/m³, 20.1 kg of water would be exhausted by the paddlewheel every second. Observing the molar mass of water to be 0.0180153 kg/mol, slightly less than 1,120 moles would be exhausted per second for reentry into solution. This is also the number of moles of water required to be split by the electrolysis chamber. As directly implied, 560 moles of oxygen and 1,120 moles of hydrogen will be produced from the electrolysis of 1,120 moles of water.

Electrolysis will consume 1,120 moles of electrons, or Faradays, for the process of splitting water into the basic elements. Ampere is defined as a Coulomb running for one second. Considering that the second is the base for this electrolysis, the Coulomb should be found. By definition, there are 96,485.3383 Coulombs per Faraday. Therefore, this electrolysis requires almost 108,000,000 Coulombs every second, or 108,000,000 Amperes.

The oxygen and hydrogen gasses would then react with each other via an electrochemical reaction in a fuel cell. The byproduct or the fuel cell, pure water, is exhausted into the water column. The reaction at the fuel cell produces current, which is reintroduced into solution for electrolysis. If this were the only current introduced for electrolysis, the system would fail.

The theoretical exchange between electrolysis and the fuel cell is the primary; current generation of the system. A fuel cell merges hydrogen with oxygen via an electrochemical reaction: 2H₂+O₂→2H₂O+2e⁻. One mole of electrons is produced for every mole of water. The number of moles of hydrogen consumed is 1,120 and of oxygen is 560. This electrochemical reaction will created 1,120 moles of water and no more than 1,120 Faradays every second. As such, the fuel cell stack would produce no more than 108,000,000 Amperes and can be arranged to generate the current at 3.5 V.

A voltage of about 6 V is usually required to begin the electrolysis procedure, but not required to sustain the process. Therefore, an initial “jolt” of current is necessary, and can be obtained through transformation or when the induction dynamo is spinning at its upper bound.

The current will diminish as it travels back to the electrolysis chamber. Suppose this rate of loss is 3%, about 3,240,000 Amperes will be lost. Assuming the single induction dynamo has the same loss, about 105,000 Amperes would be lost leaving 165,000 Amperes available for consumption by the system and an outside source. The current would most likely need to be first converted it into alternating current, then transformed to usable voltage for transmission.

If one does so desire, the height of the water column can be altered as a gearing system may be implemented between the paddlewheel and the induction dynamo. The trade-off is that more water will be consumed by the paddlewheel as it is rotating faster by a multiple equal to that of the gearing ratio. Also, smaller induction dynamos can be implemented to produce current utilizing the pressure in the collection chambers. Though it may not be much, it is still extra and usable current that can be generated. In an alternative embodiment of the invention, a second water column can catch the exhausted water from the first and the above process call be repeated to create extra amperes. The process of “catching water” can be repeated multiple times for the desired effects of the designer.

The method and apparatus of the present invention detail electrical energy. There is other energy in the system, such as rotational energy and energy arising from magnetic flux that will be eventually consumed by the system, and the physical manifestation of energy, like magnets, will have to be replaced in time. Lastly, heat loss, need only be considered if actual energy is in question. The alternate energy sources are explained below.

### Part I: Energy Loss

Energy is lost by the system. This is demonstrated foremost by the deterioration of the magnetic flux density of the magnets within the induction dynamos as described above. The flux density is altered as demonstrated by the transference of electrical current between the fuel cell (also electrical generator) and the electrolysis chamber. By manually changing said magnets over the machine's life, energy is introduced by an outside source thus sustaining the system.

### Part II: Conservation of Mass

This machine's process relies heavily on the electrochemical reaction between the products created by the electrolysis of the electrochemically created byproduct. The electrolysis of water creates hydrogen and oxygen. These two gasses are introduced in a fuel cell create electricity and water. The water is then used for electrolysis and the process is reiterated.

During electrolysis, two moles of hydrogen and one mole of oxygen are created from two moles of water. Two moles of electrons are required for this process. During the electrochemical reaction in the fuel cell, two moles of electrons are created along with two moles of water as a byproduct. This requires two moles of hydrogen and one mole of oxygen. The exact number of products created by electrolysis is used in the electrochemical reaction, and the exact number of products required by electrolysis is created by the fuel cell. As stated earlier, this system will fail if no other electrical current is introduced into the electrolysis as electrons are lost in electrical transmission.

### Part III: Two Laws of Thermodynamics

The First Law of Thermodynamics is an expression of the Law of Conservation of Energy. In other words, the total amount of energy in an isolated system remains constant. Energy is often expressed as the sum of kinetic energy and potential energy. Not being able to be created or destroyed, energy can be converted from one form to another. Rising and falling matter is the energy that is harnessed. The work taken to compress gasses, raise them to a position in which they are merged, and drop the condensed water created is done by nature. Matter exists in the system and the energy required for its segregation exists, is utilized, and need not be measured. Though relevant, it should be recognized and widely accepted that nature manages the energy created/consumed by the separation of matter in a system: specifically this is a relation and reference to buoyancy. Therefore, the process does not violate the First Law of Thermodynamics as it relates to the existing matter in the system.

The Second Law of Thermodynamics states that heat cannot be transferred from a cold body to a hotter body. In other words, when heat is produced, it will only travel from a hot body to a colder body, not the other way around. Heat is a form of energy and is seen as the greatest waste or energy. Therefore, the less heat that is created in a system, the less energy is wasted from the system. The aforementioned process does not spontaneously convert thermal energy (heat) into mechanical work. Quite the contrary as heat is lost via radiation when the process is mechanized.

The invention may be embodied in other specific forms without departing from the essential attributes thereof; therefore, the illustrated embodiments should be considered in all respects as illustrative and not restrictive.

1. A method of producing an electrical current in a closed system, the method comprising:
splitting a first substance into byproducts via a first electrochemical reaction in a reservoir containing at least one electrode wherein each byproduct is collected in separate chambers;
introducing the byproducts into a reactor vessel such that each byproduct enters the vessel at separate locations;
transferring the byproducts past a first generator positioned in the reactor vessel to generate a first electrical current;
recombining the byproducts to form the first substance via a second electrochemical reaction;
transferring the recombined first substance past a second generator positioned in a return path between the reaction vessel and the reservoir to generate a second electrical current; and
reintroducing the first substance into the reservoir.

2. The method of claim 1, wherein the first substance is aqueous sulfuric acid solution wherein the first electrochemical reaction splits water of the aqueous sulfuric acid solution into hydrogen and oxygen via electrolysis.

3. The method of claim 2, wherein the reaction vessel is a fuel cell comprising an anode, a cathode, and an electrolyte.

4. The method of claim 3, wherein the method of introducing the byproducts into a reaction vessel comprises:
introducing the hydrogen into the anode of the fuel cell via a first port such that the hydrogen is split into protons and electrons that take different paths to the cathode;
introducing the oxygen into the cathode of the fuel cell via a second port;
harnessing the electrons via the second generator to produce the first electrical current.

5. The method of claim 1, wherein the second generator comprises a paddlewheel and the return path comprises a water column.

6. The method of claim 5, wherein the reaction vessel is positioned at a height above the reservoir such that the paddlewheel is adapted rotated to be rotated when the first substance falls through the water column to be reintroduced into the reservoir.

7. The method of claim 6, wherein the paddlewheel comprises a plurality of paddles, each paddle having a radius r, width w, length l and thickness c, such that a volume of the first substance expelled is defined as:
wπr²−wπ(r−1)²−wln(2r−1)arcsin(c/2r)=wl(2r−1)(π−n*arcsin(c/2r)),
where n is the number of paddles on the paddlewheel.

8. A closed system for producing electricity, the system comprising:
a reservoir with a first chamber comprising a first electrode and a first exit pathway, and a second chamber comprising a second electrode and a second exit pathway, and an input port, wherein an electrolytic solution containing a fluid substance is contained within the reservoir;
a reaction vessel having a first input port, a second input port, and an output port, wherein the reaction vessel is positioned at a height above the reservoir, and wherein the first exit pathway is operably coupled to the first input port, and the second exit pathway is operably coupled to the second input port;
a water column having a first end operably coupled to the output port of the reaction vessel and a second end distal the first end operably coupled to the input port of the reservoir; and
a paddlewheel positioned within the water column between the first end and the second end
wherein a first gas is produced from the electrolytic solution in the first chamber and the first gas enters the reaction vessel at the first input port, and a second gas is produced from the electrolytic solution in the second chamber and the second gas enters the reaction vessel, and wherein the first gas recombines with the second gas in the reaction vessel to reform the fluid substance, and wherein the fluid substance exits the reaction vessel at the output port into the water column past the paddlewheel, causing the paddlewheel to rotate.

9. The system of claim 8, wherein the electrolytic solution is aqueous sulfuric acid wherein the fluid substance is water.

10. The system of claim 8, wherein the reaction vessel is a fuel cell comprising an anode, a cathode, and an electrolyte.

11. The system of claim 8, wherein the paddlewheel comprises a plurality of paddles, each paddle having a radius r, width w, length l and thickness c, such that a volume of the fluid substance expelled is defined as:
wπr²−wπ(r−1)²−wln(2r−1)arcsin(c/2r)=wl(2r−1)(π−n*arcsin(c/2r)),
where n is the number of paddles on the paddlewheel.
